(19) United States
(12) Patent Application Publication
(10) Pub. No.: US 2015/0347940 A1
(43) Pub. Date: Dec. 3, 2015

(54) SELECTION OF OPTIMUM SERVICE PROVIDERS UNDER UNCERTAINTY

(71) Applicants: INTERNATIONAL BUSINESS MACHINES CORPORATION, Armonk, NY (US); UNIVERSITA DEGLI STUDI DI MODENA E REGGIO EMILIA, Modena (IT)

(72) Inventors: Yurdaer N. DOGANATA, Chestnut Ridge, NY (US); Asser TANTAWI, Somers, NY (US); Stefania TOSI, Sassuolo Modena (IT); Merve UNUVAR, New York, NY (US)

(73) Assignees: UNIVERSITA DEGLI STUDI DI MODENA E REGGIO EMILIA, Modena (IT); INTERNATIONAL BUSINESS MACHINES CORPORATION, Armonk, NY (US)

(21) Appl. No.: 14/287,243

(22) Filed: May 27, 2014

(51) Int. Cl. G06Q 10/06

(52) U.S. Cl. CPC G06Q 10/06311

(57) ABSTRACT

Various embodiments select at least one service provider from a plurality of service providers in a computing environment. In one embodiment, a service request is received from a user. The service request comprises at least a set of service requirements to be satisfied by at least one service provider. A satisfaction level is predicted for each of a plurality of service providers with respect to each of the set of service requirements. The prediction is based on a prediction satisfaction model associated with each of the plurality of service providers. A probability of an actual observed satisfaction level being higher than at least a user defined threshold is calculated for each of the predicted satisfaction levels. At least one service provider is selected from the plurality of service providers for satisfying the service request based on the probability that has been calculated for each satisfaction level predicted.

### BACKGROUND

The present disclosure generally relates to computing environments comprising computing resource providers, and more particularly relates to selecting optimum computing resource providers within a computing environment.

A user of computing services such as (but not limited to) an infrastructure cloud service has the option to select a service provider where their resources are provisioned. A computing resource zone is a data center physically isolated from other computing resource zones. Computing resource zones are usually offered in various geographies. However, computing resource zones offered by a given provider are generally not identical. For example, the hardware, infrastructure, type and version of management stack, and load characteristics can differ across the offered computing resource zones. As a result, services offered by different computing resource zones can also vary.

### BRIEF SUMMARY

In one embodiment, a method with an information processing system for selecting at least one service provider in a computing environment is disclosed. The method comprises receiving a service request from a user. The service request comprises at least a set of service requirements to be satisfied by at least one service provider. A satisfaction level is predicted for each of a plurality of service providers with respect to each of the set of service requirements. The prediction is based on a prediction satisfaction model associated with each of the plurality of service providers. A probability of an actual observed satisfaction level being higher than at least a user defined threshold is calculated for each of the predicted satisfaction levels. At least one service provider is selected from the plurality of service providers for satisfying the service request based on the probability that has been calculated for each satisfaction level predicted for each of the plurality of service providers.

In another embodiment, an information processing system for selecting at least one service provider in a computing environment is disclosed. The information processing system comprises a memory and a processor communicatively coupled to the memory. A service provider manager is communicatively coupled to the memory and the process. The service provider manager is configured to perform a method. The method comprises receiving a service request from a user. The service request comprises at least a set of service requirements to be satisfied by at least one service provider. A satisfaction level is predicted for each of a plurality of service providers with respect to each of the set of service requirements. The prediction is based on a prediction satisfaction model associated with each of the plurality of service providers. A probability of an actual observed satisfaction level being higher than at least a user defined threshold is calculated for each of the predicted satisfaction levels. At least one service provider is selected from the plurality of service providers for satisfying the service request based on the probability that has been calculated for each satisfaction level predicted for each of the plurality of service providers.

In a further embodiment, a computer program product for selecting at least one service provider in a computing environment to satisfy at least one service request is disclosed. The computer program product comprises a storage medium readable by a processing circuit and storing instructions for execution by the processing circuit for performing a method. The method comprises receiving a service request from a user. The service request comprises at least a set of service requirements to be satisfied by at least one service provider. A satisfaction level is predicted for each of a plurality of service providers with respect to each of the set of service requirements. The prediction is based on a prediction satisfaction model associated with each of the plurality of service providers. A probability of an actual observed satisfaction level being higher than at least a user defined threshold is calculated for each of the predicted satisfaction levels. At least one service provider is selected from the plurality of service providers for satisfying the service request based on the probability that has been calculated for each satisfaction level predicted for each of the plurality of service providers.

### BRIEF DESCRIPTION OF THE SEVERAL VIEWS OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present disclosure, in which:

FIG. 1 is a block diagram illustrating one example of an operating environment according to one embodiment of the present disclosure;

FIG. 2 is a block diagram illustrating a detailed view of a service provider manager according to one embodiment of the present disclosure;

FIG. 3 is a block diagram illustrating one example of an overall system architecture for selecting a service provider based on its predicted satisfaction level according to one embodiment of the present disclosure;

FIG. 4 shows one example of a training data for training a prediction model according to one embodiment of the present disclosure;

FIG. 5 shows an overall view of a process for generating satisfaction level prediction models for a plurality of service providers according to one embodiment of the present disclosure;

FIG. 6 is a block diagram illustrating one example of an overall system architecture for selecting an optimum service provider under uncertainty according to one embodiment of the present disclosure;

FIG. 7 illustrates one example of a confusion matrix comprising historical predicted satisfaction levels and the actual observed satisfaction levels for a service provider according to one embodiment of the present disclosure.

FIG. 8 illustrates one example of a confusion matrix comprising cumulative probability distributions of the data within the confusion matrix of FIG. according to one embodiment of the present disclosure.

FIG. 9 shows a graph illustrating the cumulative probability distributions in FIG. 9 according to one embodiment of the present disclosure.

FIG. 10 is an operational flow diagram illustrating one example of an overall process for generating satisfaction level prediction models for service providers according to one embodiment of the present disclosure;

FIG. 11 is an operational flow diagram illustrating one example of a process for predicting the satisfaction level of service providers according to one embodiment of the present disclosure;

FIG. 12 is an operational flow diagram illustrating one example of a process for selecting an optimum service provider under uncertainty according to one embodiment of the present disclosure;

FIG. 13 illustrates one example of a cloud computing node according to one embodiment of the present disclosure;

FIG. 14 illustrates one example of a cloud computing environment according to one example of the present disclosure; and

FIG. 15 illustrates abstraction model layers according to one example of the present disclosure.

### DETAILED DESCRIPTION

Generally, service users are made aware of only a small subset of the differences between computing services offered across related computing resource zones. For example, the differences between the types of offered zone instances, their sizes, and prices are published to the users. However, service users have observed a number of differences in the quality of service provided by computing resource zones that are not captured in the advertised attributes of the different zones. For example, business applications deployed across independent computing resource zones may experience different Quality of Service (QoS) due to non-uniform physical infrastructures. Since the perceived QoS against specific requirements are generally not published, selecting a computing resource zone that would most satisfy the user requirements is a challenge.

However, one or more embodiments of the present disclosure predict unpublished computing resource zone (e.g., service provider) behavior. This predicted behavior is used to determine a probabilistic guarantee for the satisfaction of user service requirements by one or more service computing resource zones. A computing resource zone can then be selected to satisfy the user request based on the probabilistic guarantee. In addition, prediction models are built from historical usage data for each computing resource zone and are updated as the nature of the zone and requests change.

Operating Environment

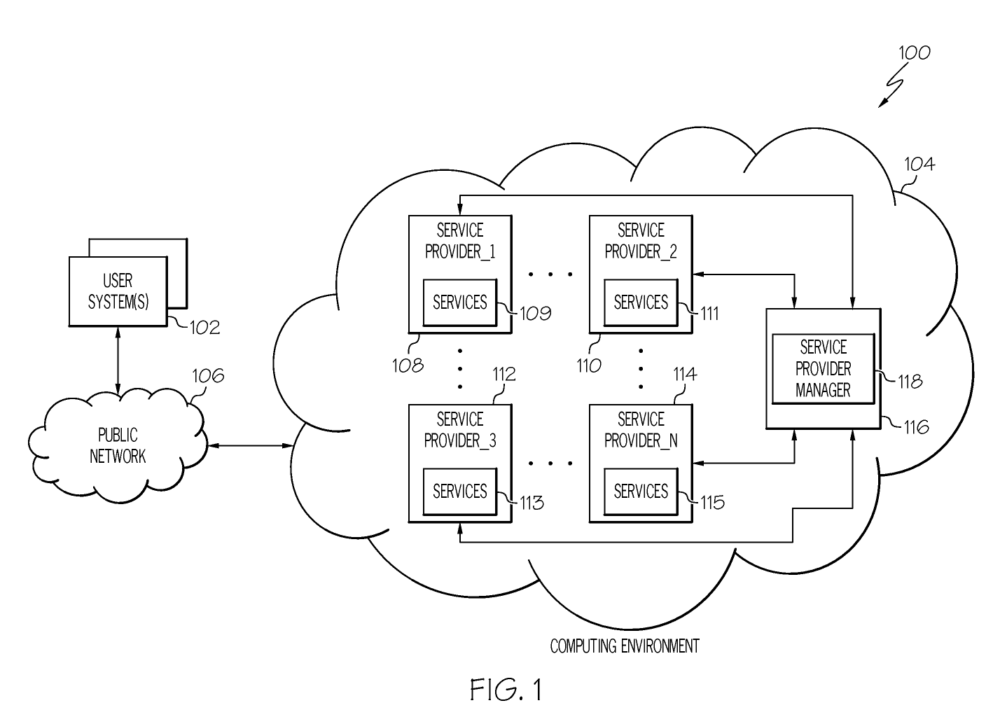

FIG. 1 shows one example of an operating environment 100 for selecting optimum service providers for satisfying a user service request. In particular, FIG. 1 shows one or more client/user systems 102 communicatively coupled to one or more computing environments 104 via a public network 106 such as the Internet. The user systems 102 can include, for example, information processing systems such as desktop computers, laptop computers, servers, wireless devices (e.g., mobile phones, tablets, personal digital assistants, etc.), and the like. In some embodiments, the one or more computing environments 104 are cloud-computing environments. However, in other embodiments, these environments 104 are non-cloud computing environments.

The user systems 102 access the computing environment 104 via one or more interfaces (not shown) such as a web browser, application, etc. to utilize computing resources/services 109, 111, 113, 115 provided by one or more service providers. It should be noted that throughout this discussion the terms “computing resources” and “services” are used interchangeably. Examples of computing resources/services are applications, processing, storage, networking, and/or the like. Computing resources/services 109, 111, 113, 115 are provided by and/or are hosted on a plurality of physical information processing systems 108, 110, 112, 114 herein referred to as “service providers” or “computing resource zones”. In other embodiments, a service provider is an entity that owns the computing resources/services offered the information processing systems 108, 110, 112, 114, and/or that owns the information processing systems 108, 110, 112, 114. The information processing systems 108, 110, 112, 114, in one embodiment, reside in different locations. However, two or more of the systems 108, 110, 112, 114 can reside at the same location. It should be noted that the computing resources/services 109, 111, 113, 115 could also be provided by and/or hosted on one or more virtual machines being executed by one or more of the physical information processing systems 108, 110, 112, 114.

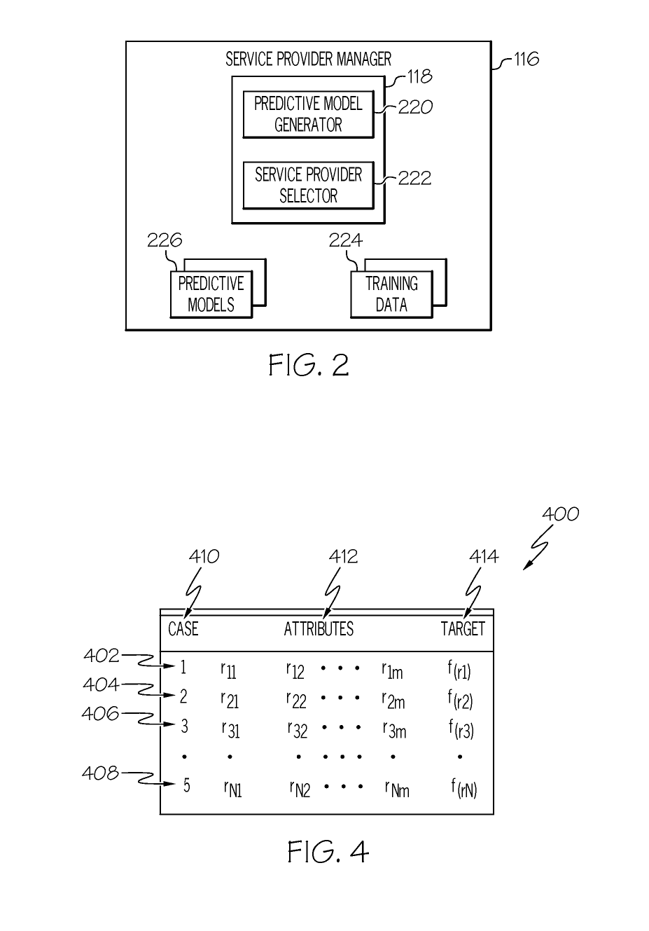

The computing environment 104 further comprises one or more information processing systems 116 comprising a service provider manager (SPM) 118. The SPM 118, in one embodiment, comprises a prediction model generator 220, and a service provider selector 222, as shown in FIG. 2. The information processing system 116 further comprises prediction models 226 (also referred to herein as “predictive models 226”) and training data 224, which are discussed in greater detail below. It should be noted that the information processing system 116 is not required to reside within the computing environment 104.

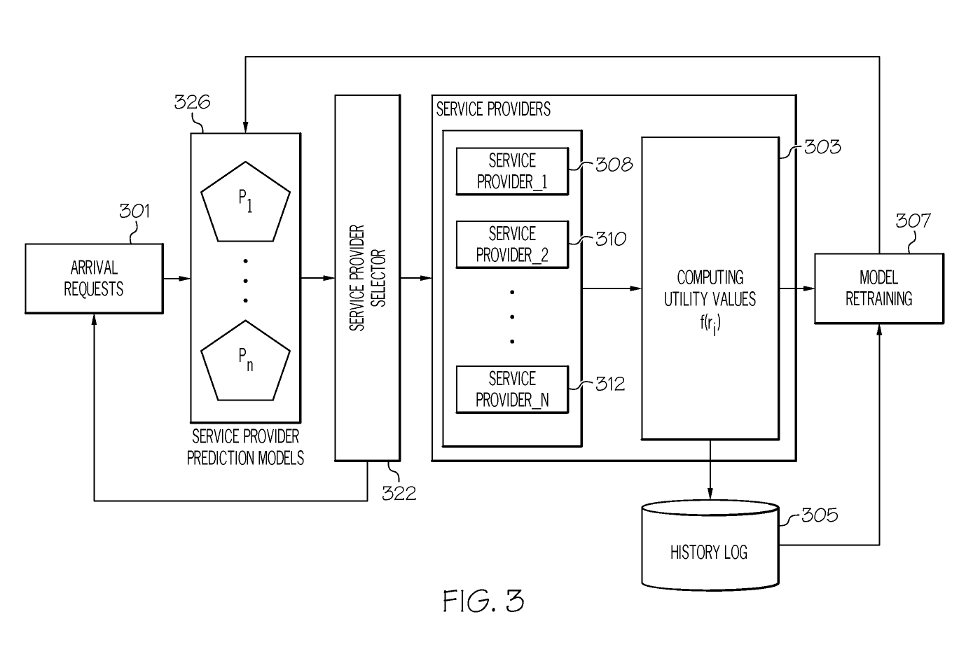

As shown in FIG. 3, the SPM 118 receives a service request 301 from a user and automatically selects one or more service providers, which provide at least one service that can satisfy the request. A service request 301, for example, is a set of service requirements demanded by the user. These requirements can be (but are not limited to) the desired quality of service attributes for services provisioned to satisfy the request, and the importance of these attributes. Based on these inputs, the service provider selector 322 of the SPM 118 selects one or more service providers 308, 310, 312. The SPM 118 deploys an instance of the service request on the selected service provider(s). In one embodiment, deploying an instance of the service request comprises provisioning a set of computing resources (e.g., services) at the selected service provider(s) that satisfies the requirements of the user service request. Measurements, such as (but not limited to) QoS measurements, are taken for the deployed instance. The SPM 118 then calculates an actual utility function for the service. The utility function provides an indication as to how well the deployed instance satisfied the requirements of the user's request.

The SPM 118 calculates and/or records observed (actual) utility values 303 for a plurality of deployed instances, and stores this data in a history log 305. The SPM 118 utilizes these historical utility values as training data 224 to train (and re-train 307) prediction models 326 for each service provider 308, 310, 312. The prediction models 326 assist the SPM 118 in learning unpublished attributes of a computing service provided by the service providers 308, 310, 312. The service SPM 118 accommodates time varying changes in service attributes by reconstructing the models based on continuously changing input data. Given the prediction model 326 and requirements specified in a new service request, the SPM 118 formulates and solves an optimization problem for selecting the optimum service provider to satisfy the request.

One advantage of embodiments of the present disclosure is that service users are moved from the common practice of manually selecting a service provider by relying on community knowledge to the automatic selection of customized solutions focused on their needs. Also, embodiments of the present disclosure are not limited to single provider deployments. For example, one or more embodiments are also applicable to deployments across multiple providers, i.e., the resources/services can be placed in different zones of different providers. In addition, one or more embodiments can be utilized by cloud brokering services in a multi-cloud setting.

Selecting Optimum Service Providers Under Uncertainty

The following is a more detailed discussion regarding prediction-based selection of service providers. As discussed above, the SPM 118 utilizes prediction models 226 for each provider 108, 110, 112, 114 to select one (or more) of these providers to satisfy a user service request. The model generator 220 creates prediction models 226 based on historical usage data (referred to herein as “training data 224”) stored in history logs associated with the service providers 108, 110, 112, 114. The training data 224 is generated based on deploying an instance of a service request to a service provider(s) 108, 110, 112, 114. In one embodiment, deploying an instance of a service request comprises provisioning one or more services 109, 111, 113, 115 of a selected service provider(s) 108, 110, 112, 114 for the service request. The utility function of a given service provider is computed by comparing the satisfaction level of user requirements in the user request after this deployment.

In one embodiment, the training data 224 is generated after an instance of a service request has been deployed. This allows the training data 224 to be based on service provider measurements (e.g., measurements of QoS parameters) that can generally only be performed after an instance of a service request has been deployed. For example, attribute values such as service provider size, hardware infrastructure, or management stack (including instance placement policies) result in different levels of reliability and performance. Attribute values that influence the QoS offered by a service provider for a particular instance type are usually not known. Also, quality of service data for any particular instance type in a particular service provider is generally not known a priori, either. In one embodiment, a monitoring service provided by, for example, the service provider can be utilized to monitor the deployment and runtime characteristics of provisioned instances of service requests.

With respect to generating training data/samples, the model generator 220 receives one or more user service requests as an input. The user service request, in one embodiment, is represented by a vector rᵢ. The i^{th} user requirement represented with the vector rᵢ=[rᵢ₁, rᵢ₂, . . . , rᵢₘ], where rᵢⱼ, j=1, . . . , m, specifies the j^{th} requirement of user i expected to be satisfied by its deployment in a service provider. User requirements include (but are not limited to): resources such as the resource amounts required by the user (e.g., CPU, memory etc.); QoS criteria such as quality of service objective that a user wants to achieve (e.g., highest reliability, minimum execution time, highest performance); constraints such as restrictions around possible service provisioning (e.g., locality constraints, service type constraints, load balancing constraints); user instance types such as the type of instance the user wants to run; and user machine types such as the type of machine that the user requires the service provider to provide.

The SPM 118 selects at least one of the service providers 108, 110, 112, 114 and deploys/provisions at least one service 109, 111, 113, 115 in this service provider for the request rᵢ, where the service(s) 109, 111, 113, 115 match the set of requirements in the request rᵢ. The model generator 220 then obtains measurements/data for the service provider with respect to the request. These measurements comprise data such as (but not limited to) the architecture of a node on which the instance of the service request was deployed, notifications of its failure and recovery, and runtime performance measurements such as throughput of various resources, delays, etc. The model generator 220 evaluates the measurements of the service provider against the requirements rᵢⱼ specified in the request rᵢ. The result of this evaluation is referred to as a “satisfaction level”.

For example, let cᵢₖ∈[0,1] denote the satisfaction level of requirement rᵢₖ. If the requirement rᵢₖ is fully satisfied, cᵢₖ=1; otherwise 0<cᵢₖ<1. In one embodiment, the evaluation process produces a vector of satisfaction levels Cᵢ^{T}=[cᵢ₁, cᵢ₂, . . . , cᵢₘ] for the deployed request rᵢ with respect to its service provider. In one embodiment, the vector of satisfaction levels Cᵢ^{T}=[cᵢ₁, cᵢ₂, . . . , cᵢₘ] is defined by a utility function ƒ(rᵢ)∈[0,1]. The utility function reaches its maximum value of 1 when there is complete satisfaction. The value of ƒ(rᵢ) depends on how much the requirements of an incoming request are satisfied by the service provider for which an instance was deployed.

It should be noted that satisfaction of some requirements might be more crucial than others. Therefore, the satisfaction level of each requirement may have different significance. The weight vector Wᵢ^{T}=[wᵢ₁, wᵢ₂, . . . , wᵢₘ] denotes the significance levels for requirements rᵢ. A higher value of wᵢₖ indicates a stronger significance of requirement rᵢₖ with respect to the other requirements of the request. One non-limiting example of defining the utility function ƒ(rᵢ)∈[0,1] is to take the linear combination of the satisfaction level Cᵢ^{T} for each incoming request and the associated weights Wᵢ^{T} multiplied by an indicator function φ(rᵢ). The indicator function is used to set the satisfaction level to zero when the request is rejected. In one example, a request is rejected if the service providers do not have enough available capacity to satisfy the request. Rejection depends on the admission/placement policy. In one embodiment, the utility function is defined as:

$$\begin{matrix}f ( {r}_{i} ) = φ ( {r}_{i} ) {\sum }_{j = 1}^{m} {w}_{ij} {c}_{ij} = {W}_{i}^{T} {C}_{i} , & ( EQ 1 ) \\ where & \\ φ ( {r}_{i} ) = \{ \begin{matrix}0 & if the request is rejected \\ {( {\sum }_{j} {w}_{ij} )}^{- 1} & otherwise .\end{matrix} & ( EQ 2 )\end{matrix}$$

The satisfaction level for user i against the requirement rᵢₖ is cᵢₖ∈[0,1]. The weight w_{ik∈} [symbol] _{≧0} indicates the importance of satisfying a particular requirement. Note that the selection of φ(rᵢ)=(Σⱼwᵢⱼ)⁻¹ when there is no rejection normalizes that weight vector and limits the maximum possible value of ƒ(rᵢ) to 1.

Consider one example with the following requirement vector for an incoming service request: rᵢ=[r_{S}, r_{L}, r_{I}, r_{A}, r_{M}]. This request comprises requirements related to the size, supported instance and infrastructure type, and reliability of a service provider. The description of the requirement attributes are as follows:

r_{S}: Requested CPU and RAM resources where r_{S}∈{micro, small, medium, large, xlarge}.

r_{L}: Level of reliability where r_{L}∈{Low, Medium, High}.

r_{I}: Tolerance to interruption where r_{I}∈[0, 1].

r_{A}: Requested instance type where r_{A}∈{Compute, Storage, Memory Instance}.

r_{M}: Requested machine type where r_{M}∈{TypeA, TypeB}.

In this example, the SPM 118 deploys an instance of the service request to at least one of the service providers 108, 110, 112, 114 based on the user request. As discussed above, deploying an instance of the service request comprises provisioning a set of computing resources (services) at a selected service provider(s) that satisfies the requirements included within the service request. After deployment, the model generator 220 determines the satisfaction level of the requirements within the request. The satisfaction level is determined based on measurements obtained from a monitoring tool(s) deployed along with the instance. The measured satisfaction level for each requirement is captured by vector Cᵢ^{T}. For example, assume that the service request comprised the following requirement vector rᵢ∈{“large”, “medium”, “1”, “Compute intense”, “Machine Type A”}. The model generator 220 observes the following satisfaction vector:
Cᵢ^{T}=[0, 1, 0, 1, 1].

Note that, in one embodiment, partial satisfaction levels are not considered. Therefore, the size and tolerance to interruption requirements of the incoming request, r_{S}={“large”} and r_{I}={“1”}, are not satisfied while other requirements are fully satisfied. If the associated weight vector is
Wᵢ^{T}=[0.2, 0.3, 0.3, 0.1, 0.1]
   the model generator 220 computes the utility function for rᵢ as

$$f ( {r}_{i} ) = \{ \begin{matrix}{W}_{i}^{T} {C}_{i} = 0.5 & if the request is placed \\ 0 & if the request is rejected .\end{matrix}$$

Note that due to the weights associated with each requirement, the satisfaction level did not exceed 0.5 when more than half of the requirements are satisfied.

After the utility function for a service provider has been calculated for a given request, the model generator 220 stores the vector of satisfaction levels Cᵢ^{T}, its associated a utility function ƒ(rᵢ)∈[0,1], and the requirements of the corresponding user request as training data 224 for a given service provider 108, 110, 112, 114.

FIG. 4 shows a table 400 illustrating one example of training data for a given service provider. In the example shown in FIG. 4, each row 402, 404, 406, 408 in the table 400 is training data generated by the model generator 220 for a given user request with respect to the service provider associated with the table 400. Each set of training data in the table comprises a unique identifier 410, a set of attributes 412 identifying the requirements of the user service request, and a calculated utility function 314. The training data within the table 400 is characterized by a tuple (rᵢ, ƒ(rᵢ)) for i=1, . . . , M where M is the size of the training set or the number of the instances used for training Here, ƒ(rᵢ) is the empirical value of the utility function associated with the requirement vector rᵢ, and can also be referred to as the target value or the satisfaction category.

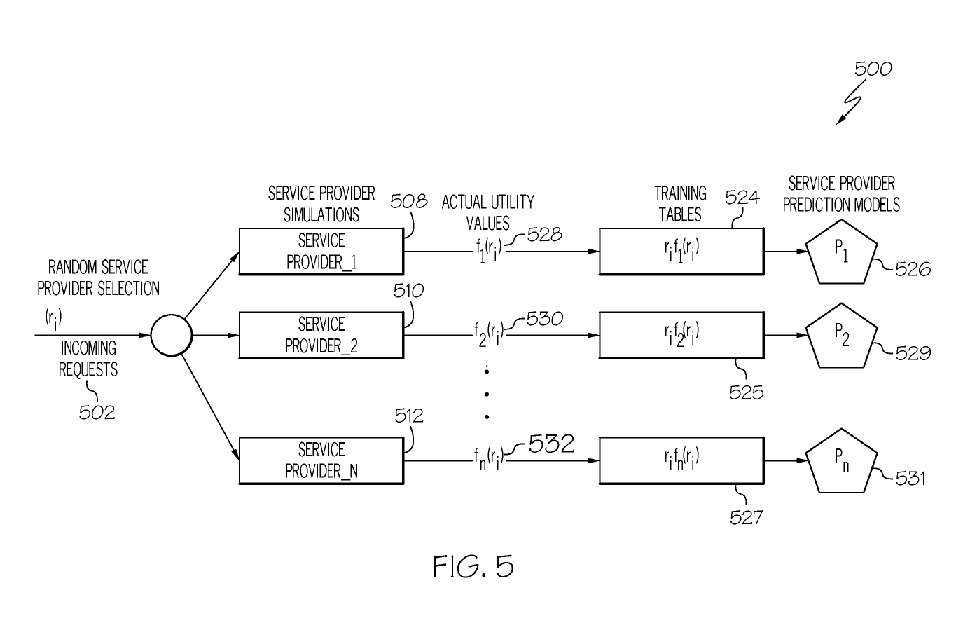

The model generator 220 utilizes the training data 224 to generate a prediction model 226 for each of the service providers. FIG. 5 shows a diagram 500 illustrating one example of the overall process for generating these prediction models. As discussed above, the SPM 118 deploys an instance of a service request for each incoming request rᵢ_{ₙ} 502 using a random selector. This random selection process uniformly distributes service requests rᵢ_{ₙ} 502 to service providers 508, 510, 512. After the deployment of a request instance, the model generator 220 calculates the utility value 528, 530, 532 for the service provider with respect to the request, as discussed above. The model generator 220 stores the calculated utility value 528, 530, 532 along with the associated requirement vector in a set of training data (training tables) 524, 525, 527 for the service provider where the service request was deployed. In this example, each row in the training data 524, 525, 527 corresponds to a single placement instance. Once the training tables/data 525, 525, 527 are built from the corresponding placement instances for each service provider 508, 510, 512, the model generator 220 generates corresponding prediction models 526, 529, 531 using one or more machine learning techniques.

A prediction model 226 maps the requirement vector rᵢ=[rᵢ₁, rᵢ₂, . . . , rᵢₘ] of an incoming service request to a user satisfaction measure defined by a utility function ƒ(rᵢ)∈[0,1]. For example, let [symbol] ₙ denote a prediction model 226, such as a classifier, for the satisfaction level of an incoming service request by a service provider in which the request was deployed. Classification models assume that utility values are discrete. However, in cases where the utility value takes continuous values, regression models are used for prediction. The model generator 220 trains [symbol] ₙ uses the training data 224 associated with service provider n such that [symbol] ₙ learns the behavior of service provider n.

After the training phase, [symbol] learns how to predict the utility function (satisfaction level) for a requirement vector rₗ as shown in the following equation:

[symbol]

(rₗ)=\tilde{f}(rₗ) (EQ 3).

Here, \tilde{f}(rₗ) is the predicted satisfaction level. The average prediction error, ē( [symbol] ), for model [symbol] is given as:

$$\overline{e} ( ℙ ) = \frac{1}{M} {\sum }_{𝓁 = 1}^{M} {[ f ( {r}_{𝓁} ) - \tilde{f} ( {r}_{𝓁} ) ]}^{2} . \qquad ( EQ 4 )$$

In order to find an unbiased estimation of the predicted error, the model generator 220 tests a trained prediction model 226 against a set of requirement vectors that are not part of the training set for validation. Cross-validation is used to evaluate the models 226 by dividing the sample data into training and validation segments. The first segment is used to learn the model and the second segment is used for validation. Equation (5) above shows how to estimate the testing error by using M test data. During the cross validation process the training and validation sets should cross-over in successive rounds such that each data point has a chance of being validated. In one embodiment, k-fold cross validation is utilized to measure the accuracy of the prediction models.

Once the prediction models 226, [symbol] , are generated for each service provider, the service provider selector 222 utilizes the models 226 to select service providers for incoming service requests that maximize the satisfaction of the requests. In this embodiment, the service provider selector 222 predicts the utility values of each service provider for incoming requests using the prediction models 226. The service provider selector 222 selects a service provider to provide a service(s) for a user request based on the predicted utility value. In one embodiment, the service provider selector 222 utilizes one or more selection policies when selecting a service provider.

In one embodiment, the service provider selector 222 selects a service provider based on determining a probabilistic guarantee for the satisfaction of the user requirements for each service provider. In some instances, users may want to know the maximum satisfaction that can be guaranteed by the selected service provider for a specific percentage of the time. In other words, knowing that user satisfaction will be at least 85% more than 90% of the time is more significant than just knowing that a 95% satisfaction is likely. Therefore, one or more embodiments derive probabilistic bounds for customer satisfaction to provide a probabilistic guarantee for the satisfaction of the user requirements.

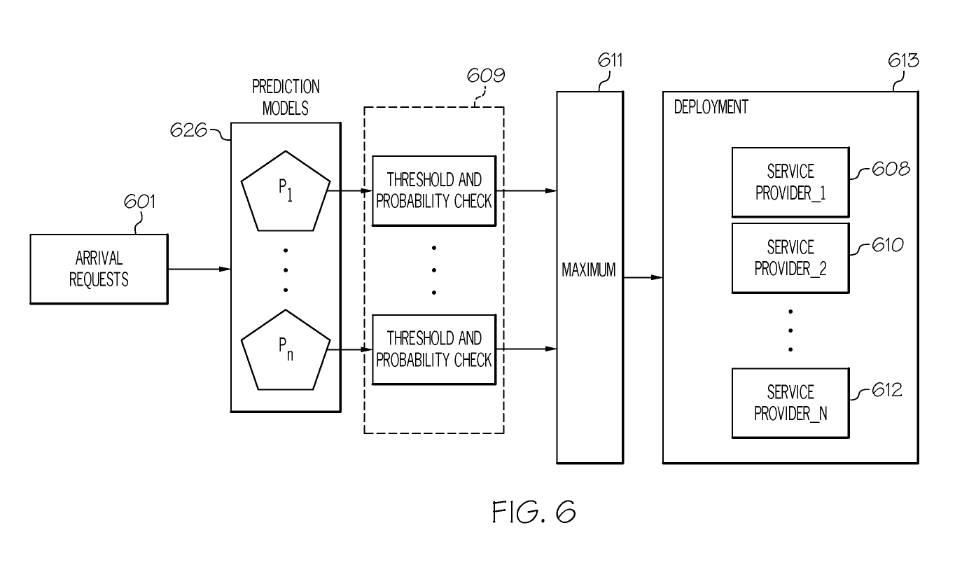

In this embodiment, a service request 601 is received, as shown in FIG. 6. The satisfaction level (utility function) of the request 601 is predicted for each service provider 608, 610, 612 using the prediction models, 626, as discussed above. For example, an incoming service request is represented by a vector rᵢ comprising one or more user requirements such that rᵢ=[rᵢ₁, rᵢ₂, . . . , rᵢₘ]. The service provider selector 222 obtains the prediction models 226 generated for the service providers 608, 610, 612. The service provider selector 222 applies each prediction model 226 to the request to predict the satisfaction level (utility function) of each service provider with respect to the request. The utility function, in one embodiment, is predicted utilizing one or more machine learning techniques. If there are N service providers, N satisfaction levels are predicted. Then, for each predicted satisfaction level, a threshold and probability check 609 is performed, which calculates the probability of the predicted satisfaction level being higher than a threshold and the probabilistic bound (confidence level) defined by the user for every service provider. The service provider selector 222 selects (in 611) the service provider 608, 610, 612 that gives the maximum of the N satisfaction levels. The service request 601 is then deployed 613 to the selected service provider 608, 610, 612, as discussed above.

In one embodiment, the SPM 118 utilizes confusion matrices to calculate the probability of a given predicted utility value being higher than a given threshold. The confusion matrices, in one embodiment, are obtained as a result of training the prediction models 226 for predicting customer satisfaction in each service provider. In one embodiment, a confusion matrix is generated for all prediction models 226. A confusion matrix is a table that comprises information about actual and predicted classifications performed by a classification system. Each column of a confusion matrix represents instances of a predicted class, while rows represent the instances in an actual class. A column in a confusion matrix gives the distribution of actual class labels for a given predicted class.

In an embodiment with N service providers, there are N prediction models 226 and an N associated confusion matrix. The class labels of this matrix are discrete customer satisfaction levels. In one example, the satisfaction levels/values are between 0 and 1. However, other satisfaction levels/values are applicable as well. As an example, if SPM 118 has observed 5 actual satisfaction levels (as stored in the history log 305), there are 5 class labels such as [0, 0.2, 0.4, 0.6, 0.8, 1.0]. The SPM 118 calculates a cumulative probability distribution from the confusion matrix of each prediction model 226. In other words, for every service provider, the SPM 118 obtains the distribution of actual satisfaction for a given predicted satisfaction level. So for N services and 5 labels there are 5×N distribution functions.

The SPM 118 uses these distribution functions to calculate the probability of actual satisfaction being greater than a user specified threshold for each service provider. Stated differently, SPM 118 calculates the following probability P for each service request against each service provider:

P(u>T|u′=S,Service Provider K) for K=1,2, . . . ,n (EQ 5).

Here u is the actual observed/recorded satisfaction level of a given request, u′ is the predicted satisfaction level when service provider K is selected, and T is a user defined threshold. The SPM 118 checks if this probability P is greater than a defined probabilistic bound (confidence level) ε, which can be user defined. If this probability P is higher than the probabilistic bound ε this guarantees that the threshold T will be satisfied by the associated service provider with ε probability. The SPM 118 identifies the service provider that gives the satisfaction level that exceeds the threshold with the highest confidence and, therefore, maximum probability (i.e., the satisfaction level with the highest probability P over ε. This maximum can be represented as follows:

Max_{K}{(P(actual satisfaction>T|predicted satisfaction j,Service Provider K)>ε} (EQ 6).

The corresponding service provider associated with this maximum satisfaction level is selected by the service selector 222. The SPM 118 then deploys an instance of the service request to the selected service provider, as discussed above.

The following is one non-limiting example illustrating the above process for selecting at least one optimum service provider under uncertainty. In this example, the SPM 118 receives a service request and predicts its satisfaction level with respect to each of a plurality of service providers, as discussed above. The SPM 118 generates a confusion matrix for each satisfaction level that has been predicted. In this example, there are five service providers. Therefore, five satisfaction levels have been predicted for the received request. The following only discusses the operations performed with respect to one of these service providers for simplicity. However, the same process/operations are performed for the remaining service providers.

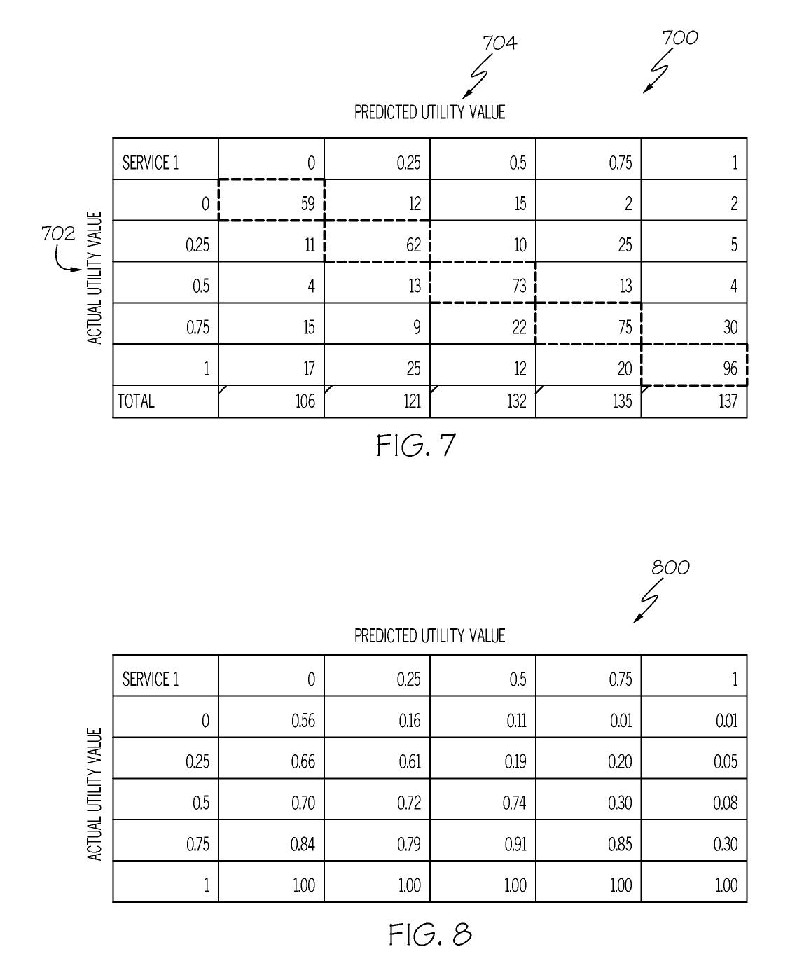

In this example, the predicted satisfaction level for the request in service provider SP_1 is 1. The SPM 118 calculates the probability of this satisfaction level being greater than a given threshold. The SPM then checks if this probability is greater than or equal to a defined confidence. For example, the SPM 118 generates a confusion matrix 700 for the prediction model 226 build for service provider SP_1, as shown in FIG. 7. In particular, the SPM 118 analyzes the prediction model 226 for the service provider SP_1 and identifies a set of predicted satisfaction levels for the service provider SP_1. The SPM 118 also analyzes the historical log 305 and identifies the actual/observed satisfaction levels for each of the set of predicted satisfaction levels. The SPM 118 identifies the counts/instances of how many times each of the actual satisfaction levels occurred for each of the set of predicted satisfaction levels. The SPM 118 then generates the confusion matrix 700 based on this information. The matrix 700 shows the distribution of actual satisfaction levels (left-most column 702) over predicted levels (top-most row 704). The diagonal 706 comprises the correct predictions.

Once the confusion matrix 700 is generated for the service provider SP_1, the SPM 118 calculates the distributions of predicted satisfaction levels from the service confusion matrices. For example, based on the confusion matrix 800 in FIG. 7, the SPM 118 determines that for the predicted value of 0, 56% of actual satisfaction levels are 0; for a predicted value of 0.25, 10% of actual satisfaction levels are 0.25; for the predicted value of 0.5, 4% of actual satisfaction levels are 0.5; for the predicted value of 0.75, 14% of actual satisfaction levels are 0.75; and for the predicted value of 1, 16% of actual satisfaction levels are 1. In one embodiment, the SPM 118 converts these individual probabilities into cumulative probability distributions, as shown in the confusion matrix 900 of FIG. 8. For example, with respect to a predicted satisfaction level of 0 and user threshold T=0.25, P(u<0.25)|u′=0) is 0.66, or P(u<0.25)|u′=0) is 1−0.66=0.34. Here, P(u<0.25)|u′=0) is the probability that the actual utility will be less than 0.25 given that the predicted utility is 0.

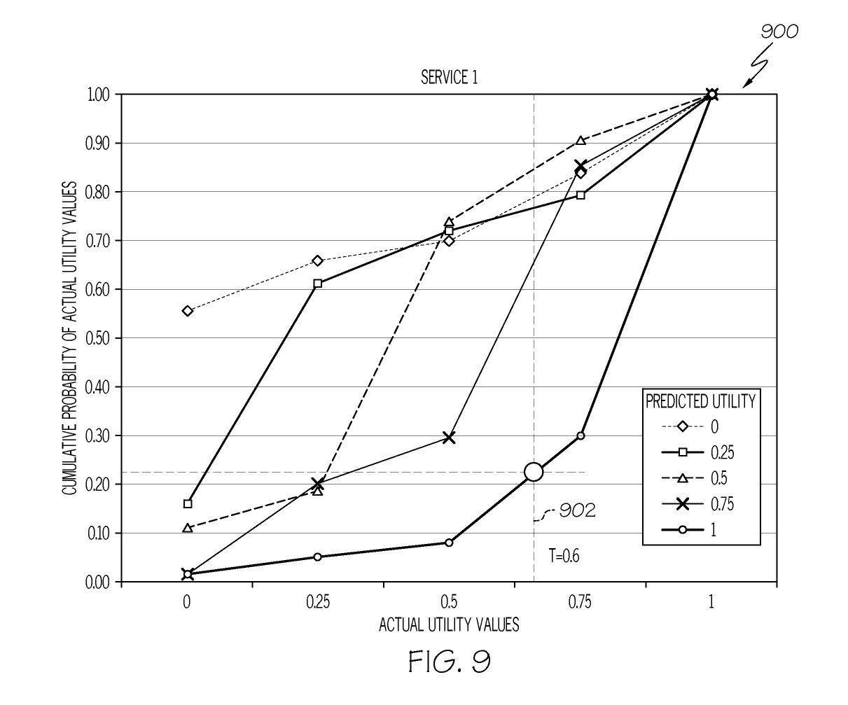

FIG. 9 shows a graph 900 illustrating the cumulative probability distribution for the actual satisfaction levels of service SP_1 for various predicted satisfaction levels for a service request. The line 1002 at T=0.6 intersects with the cumulative probability curves to obtain the probability that the actual satisfaction level is less than 0.6 or the actual satisfaction level is more than 1-0.6=0.4. For service provider SP_1, if the predicted satisfaction level is 1, then the probability that it is actually less than 0.6 is found as 0.22. This means that the probability of the actual satisfaction level being greater than 0.6 is found as 0.78. On the other hand, if the predicted satisfaction level for service SP_1 is 0.75, the probability that it is actually greater than 0.6 is found at 0.32 in FIG. 9. In other words, the SPM 118 is more confident (0.78) that the actual utility will be greater than 0.6 if the predicted utility is 1 as opposed to it being 0.75 for a threshold T=0.6.

The SPM 118 utilizes the cumulative distribution functions of the actual satisfaction level for the given predicted satisfaction level to calculate the following probability:

P^{J}(u>T|u′) (EQ 7),

which is the probability that the actual satisfaction level u will be more than the user threshold T when the predicted satisfaction level is u′ for a service provider J. In the example above, if the user defined threshold T is set to 0.6 and the user defined confidence level ε is set to 0.75, the following probability is satisfied only when the predicted value is 1 for service provider SP_1:

P¹(u>0.6|u′=1)=0.78>0.75.

Now, assume that P(u>0.6|u′=0.75)=0.95 for service provider SP_2; P(u>0.6|u′=0.5)=0.7 for service provider SP_3; and P(u>0.6|u′=0.5)=0.75 for service provider SP_4. Here, for a given service request, the probability that the actual satisfaction level is greater than 0.6 is predicted as 0.78, 0.75, 0.7, and 0.5 for services provider SP_1, SP_2, SP_3, and SP_4, respectively. Among these four service provider, service provider SP_3 is discarded since its probability does not satisfy the confidence level of 0.75. From the remaining three service providers, a maximum is achieved in service provider SP_3, a probability of 0.95. Based on the above, the SPM 118 determines that the satisfaction level will be more than 0.6 with 95% confidence if service provider SP_2 is selected. Therefore, the SPM 118 selects service provider SP_2 since its confidence level is maximum, and deploys the service request to SP_2.

Operational Flow Diagrams

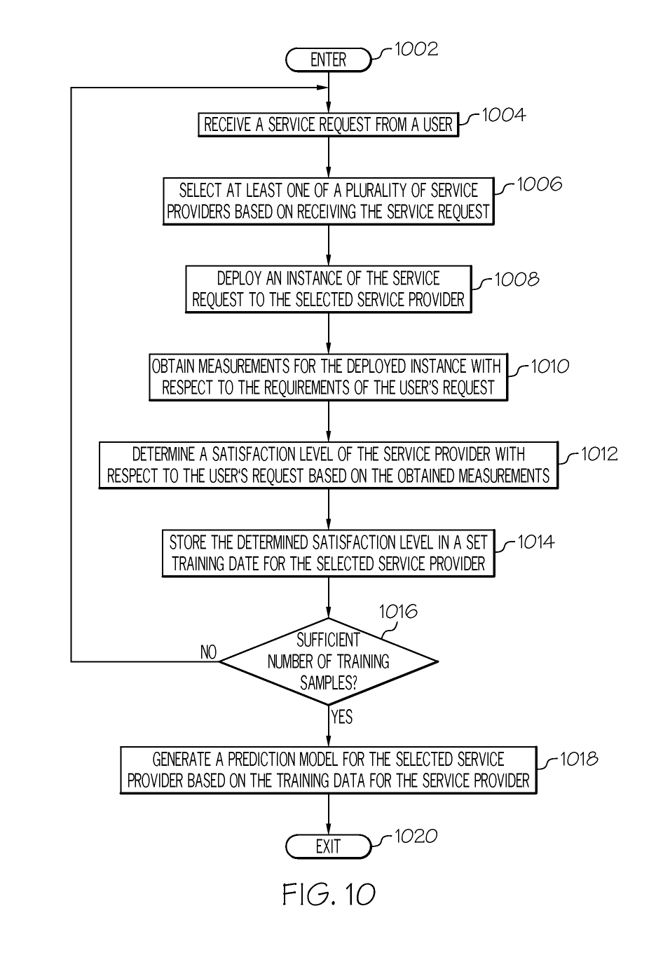

FIGS. 10-12 illustrate operational flow diagrams for various embodiments of the present disclosure. FIG. 10 is an operational flow diagram illustrating one example of an overall process for creating a prediction model for predicting a utility function/value of a service provider. The operational flow diagram of FIG. 10 begins at step 1002 and flows directly to step 1004. The SPM 118, at step 1004, receives a user's service request. As discussed above, this request comprises a plurality of requirements that are to be satisfied by one or more service providers 108, 110, 112, 114 in the computing environment 104.

The SPM 118, at step 1006, selects one of the service providers based on receiving the user's request. The SPM 118, at step 1008, deploys an instance of the request to the user at the selected service provider. As discussed above, this deployment comprises provisioning a set of computing services (e.g., computing resources) for the user at the selected service provider that satisfy the requirements in the request. The SPM 118, at step 1010, obtains measurements for the selected service provider with respect to the requirements of the user's request. These measurements comprise data including (but are not limited to) the architecture of a node on which the instance was deployed, notifications of its failure and recovery, and QoS parameters (e.g., runtime performance measurements such as throughput of various resources, delays, etc.).

The SPM 118, at step 1012, analyzes the obtained measurements and determines a satisfaction level (i.e., utility function) of the service provider with respect to the requirements of the user's request. The SPM 118, at step 1014, stores the calculated utility function as a set of training data 224 for the service provider. The SPM 118, at step 1016, determines if a sufficient number of training samples has been obtained. The result of this determination is negative, the control flows back to step 1104. If the result of this determination is positive, the SPM 118, at step 1018, generates a prediction model 226 based on the set of training data 224. The control flow exits at step 1020.

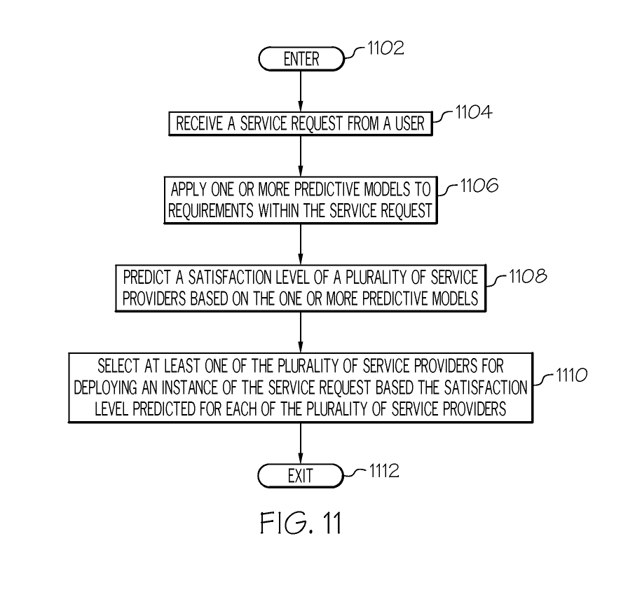

FIG. 11 is an operational flow diagram illustrating one example of an overall process for predicting satisfaction level (a utility function) of service provider. The operational flow diagram of FIG. 11 begins at step 102 and flows directly to step 1204. The SPM 118, at step 1104, receives a user's service request. As discussed above, this request comprises a plurality of requirements that are to be satisfied by one or more service providers 108, 110, 112, 114 in the computing environment 104. The SPM 118, at step 1106, applies one or more prediction models 226 to the requirements in the user's request for one or more service providers 108, 110, 112, 114 in the environment 104. The SPM 118, at step 1108, predicts a satisfaction level (i.e., utility function) of the one or more service providers 108, 110, 112, 114 with respect to the user's request based on the prediction models 226. The SPM 118, at step 1110, then selects at least one of the service providers 108, 110, 112, 114 for deploying an instance of the user's request based on the satisfaction level predicted for the service providers. The control flow exits at step 1112.

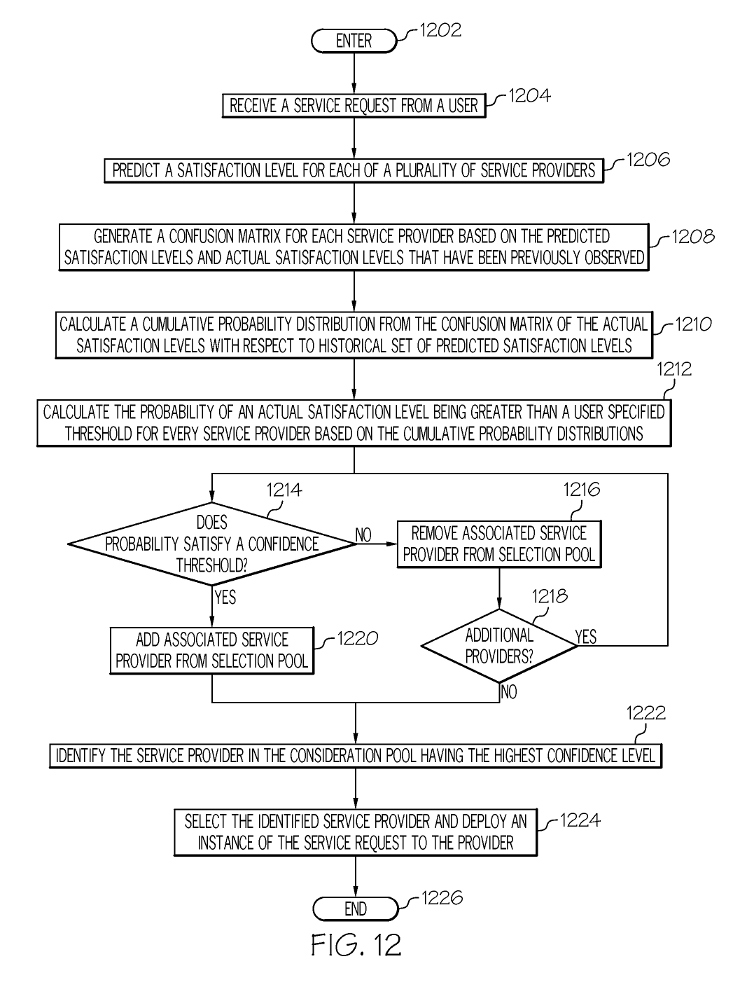

FIG. 12 is an operational flow diagram illustrating one example of an overall process for selecting an optimum service provider under uncertainty. It should be noted that FIG. 12 illustrates step 1110 of FIG. 11 in greater detail. The operational flow diagram of FIG. 12 begins at step 1202 and flows directly to step 1204. The SPM 118, at step 1204, receives a user's service request. The SPM 118, at step 1206, predicts a satisfaction level (i.e., utility function) of the one or more service providers 108, 110, 112, 114 with respect to the user's request based on the prediction models 226. The SPM 118, at step 1208, generates a confusion matrix for each of the service providers 108, 110, 112, 114 based on a historical set of predicted satisfaction levels and actual satisfaction levels that have been previously observed. The historical set of predicted satisfaction levels correspond to the satisfaction levels predicted for the plurality of service providers.

The SPM 118, at step 1210, calculates a cumulative probability distribution from the confusion matrix of the actual satisfaction levels with respect to the historical set of predicted satisfaction levels. The SPM 118, at step 1212, calculates the probability of an actual satisfaction level being greater than a user specified threshold for every service provider based on the cumulative probability distributions. The SPM 118, at step 1214, determines if the probability associated with a predicted satisfaction level satisfies the threshold with a probabilistic bound (confidence level). If the result of this determination is negative, the service provider associated with the probability is removed from consideration, at step 1216. The SPM 118, at step 1218, determines if all service providers have been considered. If the result of this determination is positive, the control flows to step 1222. If the result of this determination is negative, the flow returns to step 1214.

If the result of step 1214 is positive, the control flows to step 1220 where the SPM 118 adds the service provider associated with the probability being consider to the consideration pool. The SPM 118, at step 1222, compares each of the probabilities associated with the service providers in the consideration pool and identifies the service provider with the highest confidence level. The SPM 118, at step 1224, selects this service provider and deploys an instance of the service request to the provider. The control flow then exits at step 1226.

Cloud Computing

It should be understood that although the following includes a detailed discussion on cloud computing, implementation of the teachings recited herein are not limited to a cloud computing environment. Rather, embodiments of the present disclosure are capable of being implemented in conjunction with any other type of computing environment now known or later developed, including client-server and peer-to-peer computing environments. For example, various embodiments of the present disclosure are applicable to any computing environment with a virtualized infrastructure or any other type of computing environment.

For convenience, this discussion includes the following definitions which have been derived from the “Draft NIST Working Definition of Cloud Computing” by Peter Mell and Tim Grance, dated Oct. 11, 2009, which is cited in an IDS filed herewith, and a copy of which is attached thereto. However, it should be noted that cloud computing environments that are applicable to one or more embodiments of the present disclosure are not required to correspond to the following definitions and characteristics given below or in the “Draft NIST Working Definition of Cloud Computing” publication. It should also be noted that the following definitions, characteristics, and discussions of cloud computing are given as non-limiting examples.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. A cloud model may include at least five characteristics, at least three service models, and at least four deployment models.

Cloud characteristics may include: on-demand self-service; broad network access; resource pooling; rapid elasticity; and measured service. Cloud service models may include: software as a service (SaaS); platform as a service (PaaS); and infrastructure as a service (IaaS). Cloud deployment models may include: private cloud; community cloud; public cloud; and hybrid cloud.

With on-demand self-service a cloud consumer can unilaterally provision computing capabilities, such as server time and network storage, as needed automatically without requiring human interaction with a service provider. With broad network access capabilities are available over a network and accessed through standard mechanisms that promote use by heterogeneous thin or thick client platforms (e.g., mobile phones, laptops, and personal digital assistants (PDAs)). With resource pooling computing resources of a provider are pooled to serve multiple consumers using a multi-tenant model, with different physical and virtual resources dynamically assigned and reassigned according to demand. In resource pooling there is a sense of location independence in that the consumer generally has no control or knowledge over the exact location of the provided resources but may be able to specify location at a higher level of abstraction (e.g., country, state, or datacenter).

With rapid elasticity capabilities can be rapidly and elastically provisioned, in some cases automatically, to quickly scale-out and be rapidly released to quickly scale-in. To the consumer, the capabilities available for provisioning often appear to be unlimited and can be purchased in any quantity at any time. With measured service cloud systems automatically control and optimize resource use by leveraging a metering capability at some level of abstraction that is appropriate to the type of service (e.g., storage, processing, bandwidth, and active user accounts). Resource usage can be monitored, controlled, and reported providing transparency for both the provider and consumer of the utilized service.

In a SaaS model the capability provided to the consumer is to use applications of a provider that are running on a cloud infrastructure. The applications are accessible from various client devices through a thin client interface such as a web browser (e.g., web-based e-mail). In the SaaS model, the consumer does not manage or control the underlying cloud infrastructure (including networks, servers, operating systems, storage, or even individual application capabilities), with the possible exception of limited user-specific application configuration settings.

In a PaaS model a cloud consumer can deploy consumer-created or acquired applications (created using programming languages and tools supported by the provider) onto the cloud infrastructure. In the PaaS model, the consumer does not manage or control the underlying cloud infrastructure (including networks, servers, operating systems, or storage), but has control over deployed applications and possibly application hosting environment configurations.

In an IaaS service model a cloud consumer can provision processing, storage, networks, and other fundamental computing resources where the consumer is able to deploy and run arbitrary software (which can include operating systems and applications). In the IaaS model, the consumer does not manage or control the underlying cloud infrastructure but has control over operating systems, storage, deployed applications, and possibly limited control of select networking components (e.g., host firewalls).

In a private cloud deployment model the cloud infrastructure is operated solely for an organization. The cloud infrastructure may be managed by the organization or a third party and may exist on-premises or off-premises. In a community cloud deployment model the cloud infrastructure is shared by several organizations and supports a specific community that has shared concerns (e.g., mission, security requirements, policy, and compliance considerations). The cloud infrastructure may be managed by the organizations or a third party and may exist on-premises or off-premises. In a public cloud deployment model the cloud infrastructure is made available to the general public or a large industry group and is owned by an organization selling cloud services.

In a hybrid cloud deployment model the cloud infrastructure is a composition of two or more clouds (private, community, or public) that remain unique entities but are bound together by standardized or proprietary technology that enables data and application portability (e.g., cloud bursting for load-balancing between clouds). In general, a cloud computing environment is service oriented with a focus on statelessness, low coupling, modularity, and semantic interoperability. At the heart of cloud computing is an infrastructure that includes a network of interconnected nodes.

A cloud computing environment is service oriented with a focus on statelessness, low coupling, modularity, and semantic interoperability. At the heart of cloud computing is an infrastructure comprising a network of interconnected nodes.

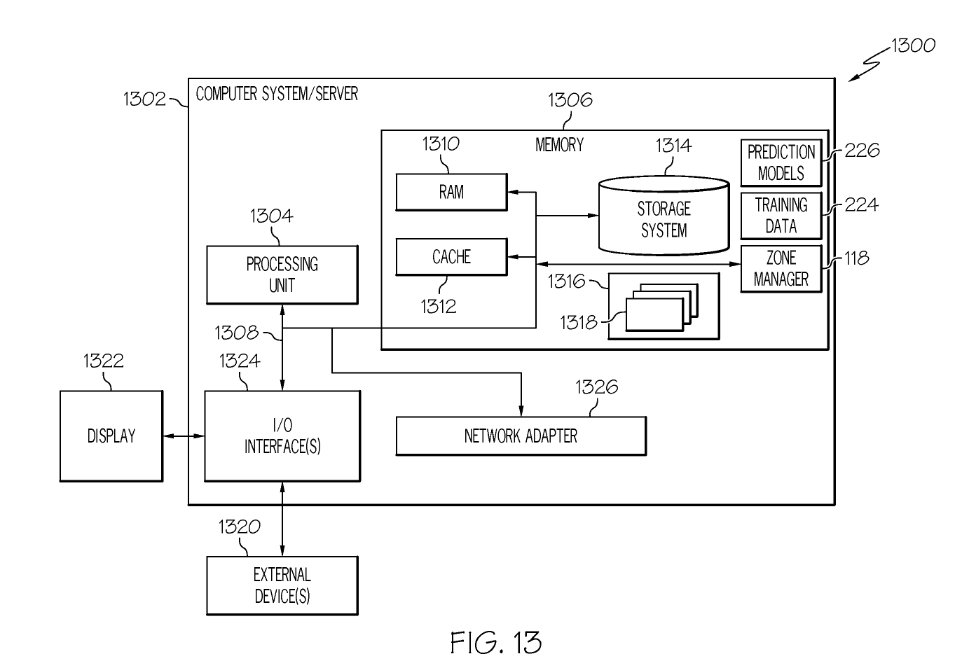

Referring now to FIG. 13, a schematic of an example of a cloud computing node is shown. Cloud computing node 1300 is only one example of a suitable cloud computing node and is not intended to suggest any limitation as to the scope of use or functionality of embodiments of the invention described herein. Regardless, cloud computing node 1300 is capable of being implemented and/or performing any of the functionality set forth hereinabove.

In cloud computing node 1300 there is a computer system/server 1302, which is operational with numerous other general purpose or special purpose computing system environments or configurations. Examples of well-known computing systems, environments, and/or configurations that may be suitable for use with computer system/server 1302 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 1302 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 1302 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 13, computer system/server 1302 in cloud computing node 1300 is shown in the form of a general-purpose computing device. The components of computer system/server 1302 may include, but are not limited to, one or more processors or processing units 1304, a system memory 1306, and a bus 1308 that couples various system components including system memory 1306 to processor 1304.

Bus 1308 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 1302 typically includes a variety of computer system readable media. Such media may be any available media that is accessible by computer system/server 1302, and it includes both volatile and non-volatile media, removable and non-removable media.

System memory 1306, in one embodiment, comprises the SPM 118, the training data 224, and the prediction models 226 discussed above. The SPM 118 can also be implemented in hardware as well. The system memory 1306 can include computer system readable media in the form of volatile memory, such as random access memory (RAM) 1310 and/or cache memory 1312. Computer system/server 1302 may further include other removable/non-removable, volatile/non-volatile computer system storage media. By way of example only, storage system 1314 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 1308 by one or more data media interfaces. As will be further depicted and described below, memory 1306 may include at least one program product having a set (e.g., at least one) of program modules that are configured to carry out the functions of various embodiments of the invention.

Program/utility 1316, having a set (at least one) of program modules 1318, may be stored in memory 1306 by way of example, and not limitation, as well as an operating system, one or more application programs, other program modules, and program data. Each of the operating system, one or more application programs, other program modules, and program data or some combination thereof, may include an implementation of a networking environment. Program modules 1318 generally carry out the functions and/or methodologies of various embodiments of the invention as described herein.

Computer system/server 1302 may also communicate with one or more external devices 1320 such as a keyboard, a pointing device, a display 1322, etc.; one or more devices that enable a user to interact with computer system/server 1302; and/or any devices (e.g., network card, modem, etc.) that enable computer system/server 1302 to communicate with one or more other computing devices. Such communication can occur via I/O interfaces 1324. Still yet, computer system/server 1302 can communicate with one or more networks such as a local area network (LAN), a general wide area network (WAN), and/or a public network (e.g., the Internet) via network adapter 1326. As depicted, network adapter 1326 communicates with the other components of computer system/server 1302 via bus 1308. It should be understood that although not shown, other hardware and/or software components could be used in conjunction with computer system/server 1302. Examples, include, but are not limited to: microcode, device drivers, redundant processing units, external disk drive arrays, RAID systems, tape drives, and data archival storage systems, etc.

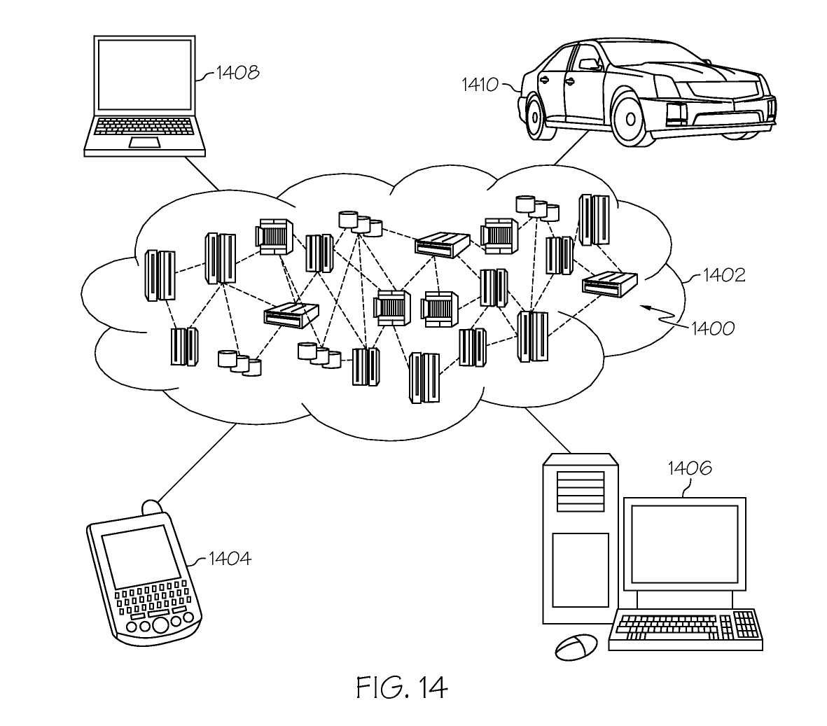

Referring now to FIG. 14, illustrative cloud computing environment 1402 is depicted. As shown, cloud computing environment 1402 comprises one or more cloud computing nodes 1000 with which local computing devices used by cloud consumers, such as, for example, personal digital assistant (PDA) or cellular telephone 1404, desktop computer 1406, laptop computer 1408, and/or automobile computer system 1410 may communicate. Nodes 1300 may communicate with one another. They may be grouped (not shown) physically or virtually, in one or more networks, such as Private, Community, Public, or Hybrid clouds as described hereinabove, or a combination thereof. This allows cloud computing environment 1402 to offer infrastructure, platforms and/or software as services for which a cloud consumer does not need to maintain resources on a local computing device. It is understood that the types of computing devices 1404, 1406, 1408, 1410 shown in FIG. 14 are intended to be illustrative only and that computing nodes 900 and cloud computing environment 1402 can communicate with any type of computerized device over any type of network and/or network addressable connection (e.g., using a web browser).

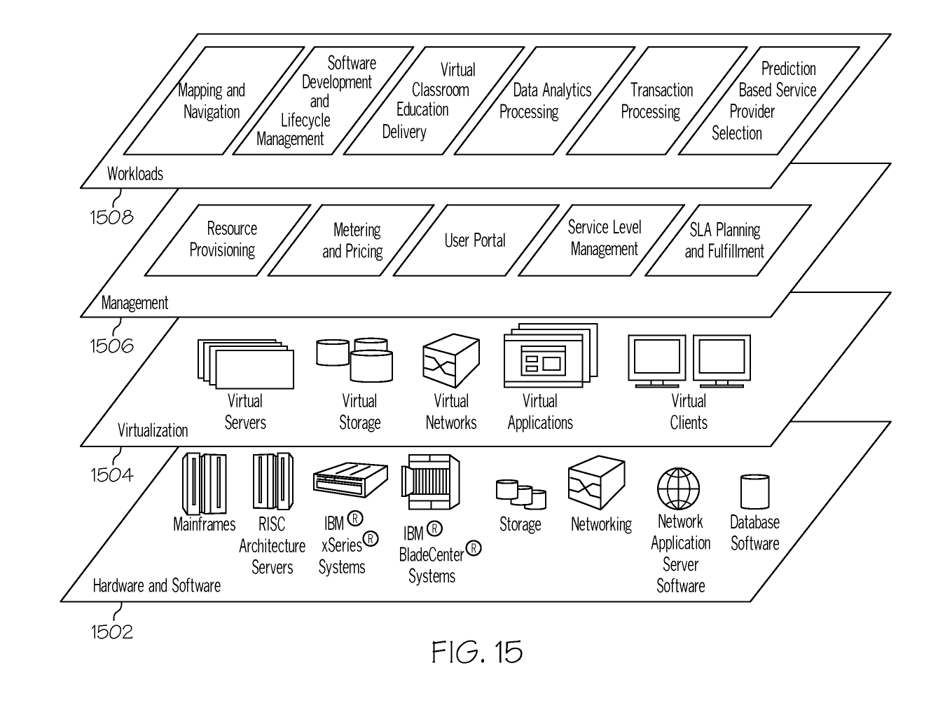

Referring now to FIG. 15, a set of functional abstraction layers provided by cloud computing environment 1402 (FIG. 14) is shown. It should be understood in advance that the components, layers, and functions shown in FIG. 15 are intended to be illustrative only and embodiments of the invention are not limited thereto. As depicted, the following layers and corresponding functions are provided:

Hardware and software layer 1502 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer 1504 provides an abstraction layer from which the following examples of virtual entities may be provided: virtual servers; virtual storage; virtual networks, including virtual private networks; virtual applications and operating systems; and virtual clients.

In one example, management layer 1506 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 1508 provides examples of functionality for which the cloud computing environment may be utilized. Examples of workloads and functions which may be provided from this layer include: mapping and navigation; software development and lifecycle management; virtual classroom education delivery; data analytics processing; transaction processing; and prediction-based service provider selection.

### Non-Limiting Examples

As will be appreciated by one skilled in the art, aspects of the present disclosure may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit”,” “module”, or “system.”

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method, with an information processing system, for selecting at least one service provider from a plurality of service providers in a computing environment, the method comprising:
receiving a service request from a user, the service request comprising at least a set of service requirements to be satisfied by at least one service provider;
predicting a satisfaction level for each of a plurality of service providers with respect to each of the set of service requirements, wherein the predicting is based on a prediction satisfaction model associated with each of the plurality of service providers;
calculating, for each of the predicted satisfaction levels, a probability of an actual observed satisfaction level being higher than at least a user defined threshold; and
selecting at least one service provider from the plurality of service providers for satisfying the service request based on the probability that has been calculated for each satisfaction level predicted for each of the plurality of service providers.

2. The method of claim 1, wherein calculating the probability for each predicted satisfaction level comprises:
obtaining, for each of the plurality of service providers, a set of historical predicted satisfaction levels and a set of actual observed satisfaction levels for each of the set of historical predicted satisfaction levels, wherein the set of historical predicted satisfaction levels correspond to the satisfaction levels predicted for the plurality of service providers.

3. The method of claim 2, wherein calculating the probability for each predicted satisfaction level further comprises:
storing, for each of the plurality of service providers, the set of historical predicted satisfaction levels and each set of actual observed satisfaction levels into a table, wherein the table comprises a distribution of actual observed satisfaction levels for each of the set of historical predicted satisfaction levels.

4. The method of claim 2, wherein calculating the probability for each predicted satisfaction level further comprises:
determining, for each of the plurality of service providers, a cumulative distribution of actual observed satisfaction levels for each of the set of historical predicted satisfaction levels.

5. The method of claim 4, wherein the probability for each of the predicted satisfaction levels is calculated based on the cumulative distribution of the actual observed satisfaction levels for the historical predicted satisfaction level corresponding to the predicted satisfaction level.

6. The method of claim 5, further comprising:
comparing, for each of the predicted satisfaction levels, the probability to a confidence threshold; and
identifying, based on the comparing, a probability from all of the probabilities that have been calculated comprising a maximum confidence level.

7. The method of claim 6, wherein selecting at least one service provider from the plurality of service providers comprises:
selecting the service provider associated with the probability comprising the maximum confidence level.

8. An information processing system for selecting at least one service provider from a plurality of service providers in a computing environment, the information processing system comprising:
a memory;
a processor communicatively coupled to the memory; and
a service provider manager communicatively coupled to the memory and the processor, wherein the service provider manager is configured to perform a method comprising:
receiving a service request from a user, the service request comprising at least a set of service requirements to be satisfied by at least one service provider;
predicting a satisfaction level for each of a plurality of service providers with respect to each of the set of service requirements, wherein the predicting is based on a prediction satisfaction model associated with each of the plurality of service providers;
calculating, for each of the predicted satisfaction levels, a probability of an actual observed satisfaction level being higher than at least a user defined threshold; and
selecting at least one service provider from the plurality of service providers for satisfying the service request based on the probability that has been calculated for each satisfaction level predicted for each of the plurality of service providers.

9. The information processing system of claim 8, wherein calculating the probability for each predicted satisfaction level comprises:
obtaining, for each of the plurality of service providers, a set of historical predicted satisfaction levels and a set of actual observed satisfaction levels for each of the set of historical predicted satisfaction levels, wherein the set of historical predicted satisfaction levels correspond to the satisfaction levels predicted for the plurality of service providers.

10. The information processing system of claim 9, wherein calculating the probability for each predicted satisfaction level further comprises:
determining, for each of the plurality of service providers, a cumulative distribution of actual observed satisfaction levels for each of the set of historical predicted satisfaction levels.

11. The information processing system of claim 10, wherein the probability for each of the predicted satisfaction levels is calculated based on the cumulative distribution of the actual observed satisfaction levels for the historical predicted satisfaction level corresponding to the predicted satisfaction level.

12. The information processing system of claim 11, further comprising:
comparing, for each of the predicted satisfaction levels, the probability to a confidence threshold; and
identifying, based on the comparing, a probability from all of the probabilities that have been calculated comprising a maximum confidence level.

13. The information processing system of claim 12, wherein selecting at least one service provider from the plurality of service providers comprises:
selecting the service provider associated with the probability comprising the maximum confidence level.

14. A computer program product for selecting at least one service provider from a plurality of service providers in a computing environment, the computer program product comprising:
a storage medium readable by a processing circuit and storing instructions for execution by the processing circuit for performing a method comprising:
receiving a service request from a user, the service request comprising at least a set of service requirements to be satisfied by at least one service provider;
predicting a satisfaction level for each of a plurality of service providers with respect to each of the set of service requirements, wherein the predicting is based on a prediction satisfaction model associated with each of the plurality of service providers;
calculating, for each of the predicted satisfaction levels, a probability of an actual observed satisfaction level being higher than at least a user defined threshold; and
selecting at least one service provider from the plurality of service providers for satisfying the service request based on the probability that has been calculated for each satisfaction level predicted for each of the plurality of service providers.

15. The computer program product of claim 14, wherein calculating the probability for each predicted satisfaction level comprises:
obtaining, for each of the plurality of service providers, a set of historical predicted satisfaction levels and a set of actual observed satisfaction levels for each of the set of historical predicted satisfaction levels, wherein the set of historical predicted satisfaction levels correspond to the satisfaction levels predicted for the plurality of service providers.

16. The computer program product of claim 15, wherein calculating the probability for each predicted satisfaction level further comprises:
storing, for each of the plurality of service providers, the set of historical predicted satisfaction levels and each set of actual observed satisfaction levels into a table, wherein the table comprises a distribution of actual observed satisfaction levels for each of the set of historical predicted satisfaction levels.

17. The computer program product of claim 15, wherein calculating the probability for each predicted satisfaction level further comprises:
determining, for each of the plurality of service providers, a cumulative distribution of actual observed satisfaction levels for each of the set of historical predicted satisfaction levels.

18. The computer program product of claim 17, wherein the probability for each of the predicted satisfaction levels is calculated based on the cumulative distribution of the actual observed satisfaction levels for the historical predicted satisfaction level corresponding to the predicted satisfaction level.

19. The computer program product of claim 18, further comprising:
comparing, for each of the predicted satisfaction levels, the probability to a confidence threshold; and
identifying, based on the comparing, a probability from all of the probabilities that have been calculated comprising a maximum confidence level.

20. The computer program product of claim 19, wherein selecting at least one service provider from the plurality of service providers comprises:
selecting the service provider associated with the probability comprising the maximum confidence level.
